(19) United States
(12) Patent Application Publication
(10) Pub. No.: US 2015/0134521 A1
(43) Pub. Date: May 14, 2015

(54) Forecasting of Deposits for a Money Handling Machine

(71) Applicant: Bank of America Corporation, Charlotte, NC (US)

(72) Inventor: Dion L. Bellamy, Valley Park, MO (US)

(21) Appl. No.: 14/601,783

(22) Filed: Jan. 21, 2015

Related U.S. Application Data
(63) Continuation of application No. 13/606,273, filed on Sep. 7, 2012.

(51) Int. Cl. G06Q 20/10; G07F 19/00

(52) U.S. Cl. CPC G06Q 20/108; G06Q 40/02; G07F 19/209; G07F 19/202
USPC 705/42

(57) ABSTRACT

A computer system obtains deposit information from a money handling device and projects a number of deposited checks at the money handling device at a subsequent time. The transaction computer determines whether the projected number of deposited checks exceeds a check threshold and generates an indicator whether deposits should be removed from the money handling device based on the determination. The number of deposited checks may be tracked at the money handling device and, if the tracked deposits are trending differently from the projected number of deposited checks, the generated indicator may be adjusted. The projected number of deposited checks at a money handling device may be compensated based on an event such as a special event or holiday. Also, the projected number of deposited checks at the money handling device may be modified when a natural disaster such as a hurricane occurs.

### CROSS-REFERENCE TO RELATED APPLICATION

This application is a continuation of U.S. application Ser. No. 13/606,273 filed on Sep. 7, 2012, entitled “Forecasting of Deposits for a Money Handling Machine,” which is incorporated herein by reference in its entirety.

### FIELD

Aspects described herein relate to a computer system that processes deposit information about a money handling machine such as an automated teller machine (ATM).

### BACKGROUND

Automated teller machines (ATMs) are an important means for providing customer services by financial institutions. Customers of financial institutions are becoming more dependent on automated systems for obtaining cash, depositing/withdrawing money to/from accounts, and paying bills. For example, ATMs are almost ubiquitous to provide financial transactions for customers. An ATM may enable customers to deposit funds into the customer's account, withdraw cash from the customer's account, make balance inquiries, and transfer money from one account to another using a plastic, magnetic-strip card with a personal identification number issued by the financial institution.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In order to enhance the convenience of automated teller machine (ATM) services, ATMs are typically placed at appropriate locations to best benefit the customers within the financial institution's operating budget. In addition, while automated systems may be more convenient than traditionally staffed locations, automated systems may experience operational problems that can disrupt service to customers. Because customers do not have direct contact with a person, possible operational problems for an ATM should be predicted and prevented, if possible, to reduce an adverse impact on customers. Consequently, techniques that enhance the convenience of ATM services and that improve ATM reliability would be beneficial to the financial industry.

At least some aspects of the disclosure relate to methods, computer-readable media, and apparatuses for forecasting when to empty the depository bin of a money handling device (e.g., an automated teller machine (ATM), video teller machine, automated deposit box, coin recycler, or the like) by receiving counts of various monetary items, such as of the number of currency bills received and collected on ATMs deposits, and/or the number of checks being received on ATM deposits. The forecasting may produce resulting data that is indicative of when and/or if depository bins in ATMs need to be emptied. This approach may reduce the cost of depository check and cash pulls, while potentially improving customer service.

According to one or more aspects, forecasting is based on incoming deposits that may include monetary items such as checks and/or cash. This approach may provide several potential benefits with respect to traditional systems. First, a financial institution (such as a bank) may have the ability to predict when to pull checks at a money handling device before bins (modules) fill and stop the money handling device from accepting subsequent deposits. Second, forecasting may provide an indication of the value for a money handling device from a deposit perspective. Consequently, a financial institution may project incoming deposits based on a money handling device's physical placement. Third, a financial institution may be able to assess the impact of losing potential deposits if a money handling device were adversely impacted by a natural disaster such as a hurricane or some other external event. Knowing the impact in advance of the natural disaster, the financial may be able to take measures to ameliorate the impact.

According to one or more aspects, a transaction computer obtains deposit information from a money handling device and projects a number of deposited checks and/or other monetary items at the money handling device at a subsequent time. The transaction computer determines whether the projected number of deposited monetary items exceeds a threshold and generates and indicator whether deposits should be removed from the money handling device based on the determination. The number of deposited monetary items may be tracked at the money handling device and, if the tracked deposits are trending differently from the projected number of deposited monetary items, the generated indicator may be adjusted.

According to one or more aspects, a projected number of deposited monetary items at a money handling device may be compensated based on an event such as a holiday. Also, the projected number of deposited monetary items at a money handling device may be modified when a natural disaster such as a hurricane occurs.

According to one or more aspects, a transaction computer obtains monetary item deposit information and check reader failure information from the money handling device and generates data that accumulates to represent an historical pattern of a ratio of a number of deposited checks to reader failure incidents. The transaction computer then generates a service indicator that is indicative of servicing the money handling device based on the pattern. The transaction computer may project the ratio to obtain a projected ratio at a subsequent (future) time and track the ratio to determine whether the ratio is trending differently from the ratio.

Various aspects described herein may be embodied as a method, an apparatus/system, and/or as one or more computer-readable media storing computer-executable instructions. Accordingly, aspects may take the form of an entirely hardware embodiment, an entirely software embodiment, or an embodiment combining software and hardware aspects. Any and/or all of the method steps described herein may be implemented by executing computer-readable instructions stored by a computer-readable medium, such as a non-transitory computer-readable medium. In addition, various signals representing data or events as described herein may be transferred between a source and a destination in the form of, e.g., light and/or other transitory electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the disclosure will occur to persons of ordinary skill in the art from a review of this disclosure. For example, one of ordinary skill in the art will appreciate that the steps illustrated herein may be performed in other than the recited order, and that one or more steps illustrated may be optional in accordance with aspects of the disclosure.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing device that may be used according to one or more illustrative embodiments.

FIG. 2 illustrates an example transaction system with a plurality of money handling devices according to one or more aspects of the present disclosure.

FIG. 3 illustrates an example money handling device according to one or more aspects of the present disclosure.

FIG. 4 illustrates an example flow chart for managing deposited checks at a money handling device according to one or more aspects of the present disclosure.

FIG. 5 illustrates an example flow chart for check deposit forecasting at a money handling device according to one or more aspects of the present disclosure.

FIG. 6 illustrates an example flow chart for deposit forecasting at a money handling device according to one or more aspects of the present disclosure.

FIG. 7 illustrates an example flow chart for forecasting deposit faults at a money handling device according to one or more aspects of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure. Also, while the present disclosure may variously refer to particular types of monetary items, such as checks, it will be understood that these references are merely examples, and that the references thereof may be replaced and/or supplemented with any other types of monetary items.

In accordance with various aspects of the embodiments, a computer system forecasts when to empty the depository bin of a money handling device by receiving counts on the number of bills received and collected on money handling device's deposits and the number of checks being received on the device's deposits. The forecasting may result in an indication of when and/or if depository bins in the device need to be emptied. This approach may reduce the cost of depository check and/or cash pulls, while potentially increasing the quality of customer service. The forecasting is based on incoming M1 deposits of monetary items that may include, for instance, checks and/or cash. (M1 money typically designates cash plus checks while M0 money designates only cash.) This approach may provide several benefits with respect to traditional systems. First, a financial institution may have the ability to predict when to pull checks and/or other monetary items at a money handling device before bins (modules) of the money handling device fill and stop the money handling device from accepting further deposits. Second, forecasting may provide an indication of the value of a money handling device to a financial institution from a deposit perspective. Consequently, a financial institution may project incoming deposits based on a money handling device's placement. Third, a financial institution may be able to assess the impact of losing potential deposits if a money handling device were adversely impacted by a natural disaster such as a hurricane. Knowing the impact in advance of the natural disaster, the financial may be able to take measures to ameliorate the impact.

The computer system may obtain deposit information from a money handling device and project a number of deposited checks and/or other monetary items at the money handling device at a subsequent time. The computer system may, for instance, determine whether the projected number of deposited checks exceeds a threshold and generate an indicator of when and/or whether deposits should be removed from the money handling device based on the determination. The number of deposited checks may be tracked at the money handling device and, if the tracked deposits are trending differently from the projected number of deposited checks, the generated indicator may be adjusted. The projected number of deposited checks at the money handling device may be compensated based on an external event. For example, the projected number of deposited checks at the money handling device may be modified when a natural disaster such as a hurricane occurs or is imminent.

In addition, the computer system may obtain check deposit information and check reader failure information from the money handling device and build a pattern of a ratio of a number of deposited checks to reader failure incidents. The computer system may then generate a service indicator that is indicative of servicing the money handling device based on the pattern, For example, personnel may be dispatched to the money handling device to maintain the reader. The computer system may project the ratio to obtain a projected ratio at a subsequent time and track the ratio to determine whether the ratio is trending differently from the projected number of deposited checks.

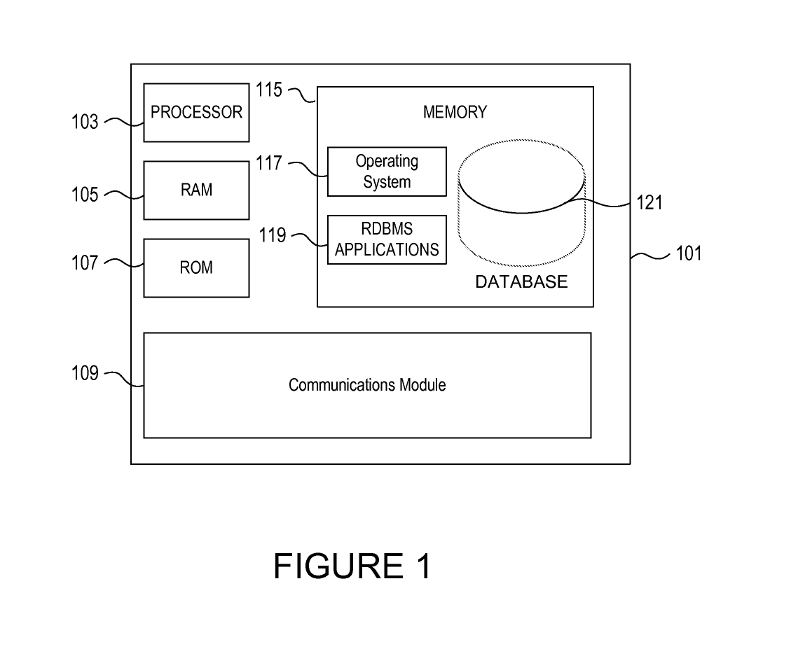

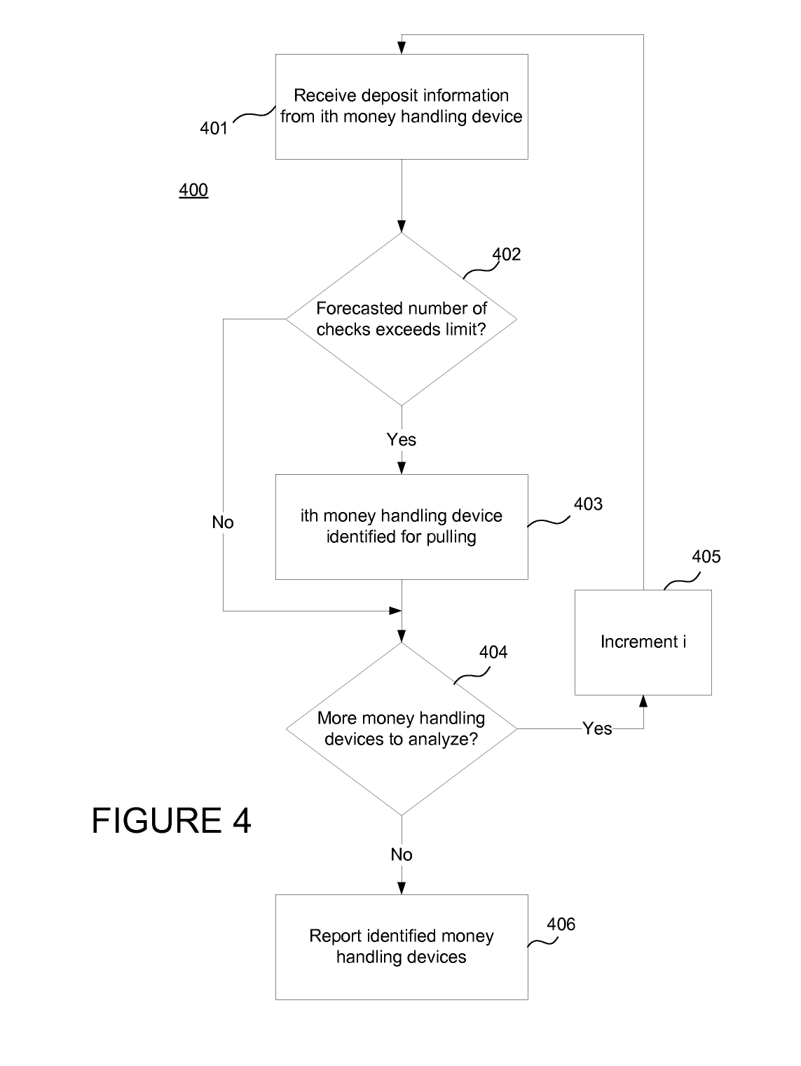

FIG. 1 illustrates an example of a computing device 101 that may be used according to one or more illustrative embodiments. For example, as will be further discussed, computing device 101 may support processes 400, 500, 600, and 700 as shown in FIGS. 4, 5, 6, and 7, respectively, to support a financial transaction system.

The present disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, computing device 101 may have a processor 103 for controlling overall operation of the computing device 101 and its associated components, such as random-access memory (RAM) 105, read-only memory (ROM) 107, communications module 109, and memory 115. Computing device 101 may include a variety of computer readable media for storing information. Computer readable media may be any available media that may be accessed by a computing device such as computing device 101 and can include both volatile and nonvolatile media, as well as removable and non-removable media.

Computer readable media may include media implemented in any method or technology for storage of information such as computer readable instructions, data structures, program modules or other data. Computer readable media may include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Although not shown, RAM 105 may store one or more software applications (e.g., computer-executable instructions) representing the application data stored in RAM 105 while the computing device is on and corresponding software applications (e.g., software tasks) are running on the computing device 101.

Communications module 109 may include, for example, a microphone, keypad, touch screen, camera, and/or stylus through which a user of computing device 101 may provide input, and may also include one or more devices for presenting user output, such as a speaker for providing audio output and/or a video display device for providing textual, audiovisual and/or graphical output.

Software may be stored within memory 115 to provide instructions to processor 103 for enabling computing device 101 to perform various functions. For example, memory 115 may store software and/or other data used by the computing device 101, such as an operating system 117, application programs 119, and an associated database 121. Also, some or all of the computer executable instructions for computing device 101 may be embodied in hardware or firmware.

Additionally, one or more application programs 119 used by the computing device 101, according to an illustrative embodiment, may include computer executable instructions for invoking user functionality related to communication including, for example, email, short message service (SMS), and voice input and speech recognition applications.

Although not required, various aspects described herein may be embodied as a method, a data processing apparatus/system, and/or a computer-readable medium storing computer-executable instructions. For example, a computer-readable medium storing instructions to cause a processor (such as processor 103) to perform steps of a method in accordance with aspects of the disclosed embodiments is contemplated.

The steps that follow in the Figures may be implemented by, for example, one or more of the components in FIG. 1 and/or other components, including other computing devices.

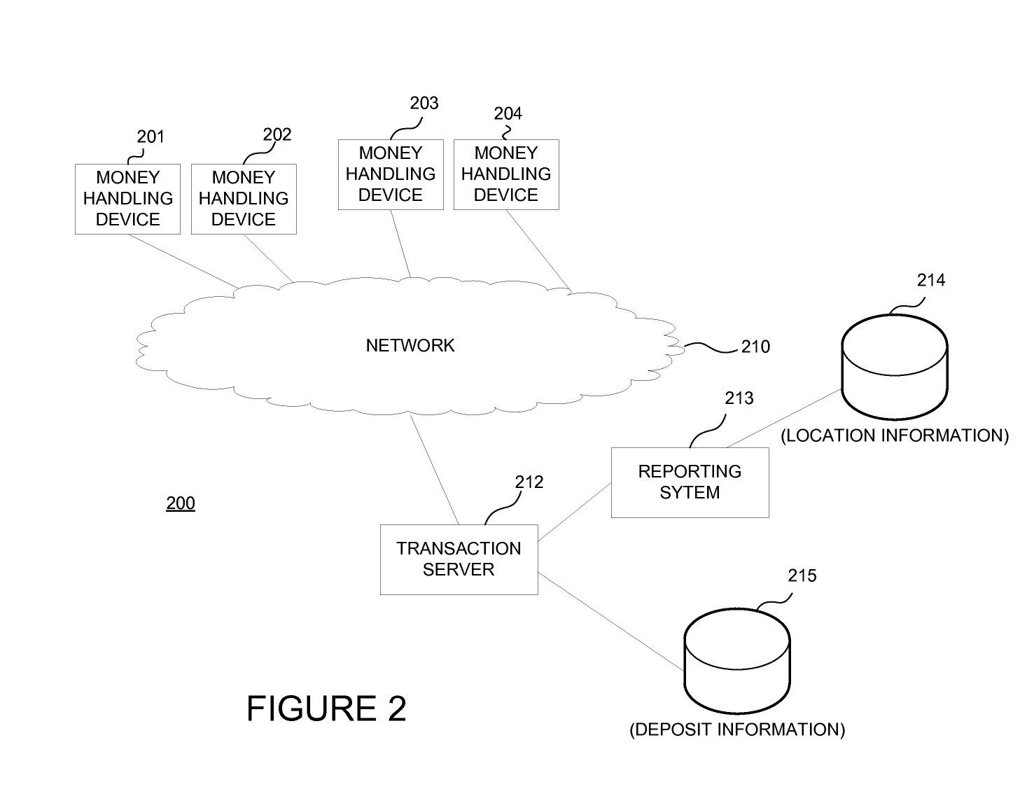

FIG. 2 shows an example transaction system 200 with a plurality of money handling devices 201-204 according to the present disclosure. Money handling devices 201-204 may include, for example, payment kiosks, point of sale systems such as cash registers, automated teller machines (ATMs), video teller machines, currency recyclers, currency dispensers, depository machines, and the like. Any of the elements of FIG. 2 may be implemented as one or more computing devices, and may be configured such as computing device 101.

Money handling devices 201-204 may process any of different categories of monetary items, including for example currency (e.g., bills/bank notes and/or coins) and checks. Currency (which may be also referred to as cash) is categorized as M0 money while the combination of currency and checks is categorized as M1 money. A customer can deposit money, including cash, personal checks, and traveler's cheques, through money handling devices 201-204.

A financial institution can communicate with money handling devices 201-204 through a network 210. The financial institution may monitor money handling devices 201-204 through transaction server 212 that executes different applications to monitor transaction system 200. Transaction server 212 may receive deposit information from money handling devices 201-204 when a customer deposits money (funds) at one of the money handling devices. Deposit information may include, for instance, the amount of deposited cash, number of deposited, and image information of each check. From the deposit information, transaction server 212 may obtain the amount of cash and the amount of deposited checks to determine the total deposit amount.

As will be further discussed, transaction server 212 may store deposit information at storage 215 so that deposit information can be later retrieved by time (e.g., day of week, date of month, and hour) to determine whether a pattern exists for deposit activity at one or more money handling devices 201-204. Storage 215 may include one or more computer-readable media configured to store data. The data may be stored and arranged so as to be queryable via a database program.

Transaction server 212 may process deposit information from money handling devices 201-204 over a period of time and further process the aggregated deposited information in order to determine whether any designated regions of money handling devices are filled or may become filled within a projected period of time. For example, as will be further discussed, money handling device 201-204 may separate stackers (bins) for different currency denominations and for deposited checks. If so, transaction server 212 may send status information about the identified money handling device so that a report can be generated at reporting system 213 informing support personnel to travel to the identified money handling device to correct the identified problem within a projected time period. For example, reporting system 213 may map, through data structure 214, the location of the identified money handling device from transaction server 212 and may generate a service route of service personnel to travel to one or more identified money handling devices 201-204. In addition, reporting system 213 may include a description of the problem at the identified money handling device 201-204. For example, the designated module for storing deposited checks may be filled or forecasted to be filled within a projected time. If the designated module for storing checks becomes filled, then the money handling device 201-204 may not be able to process subsequent deposits that include checks.

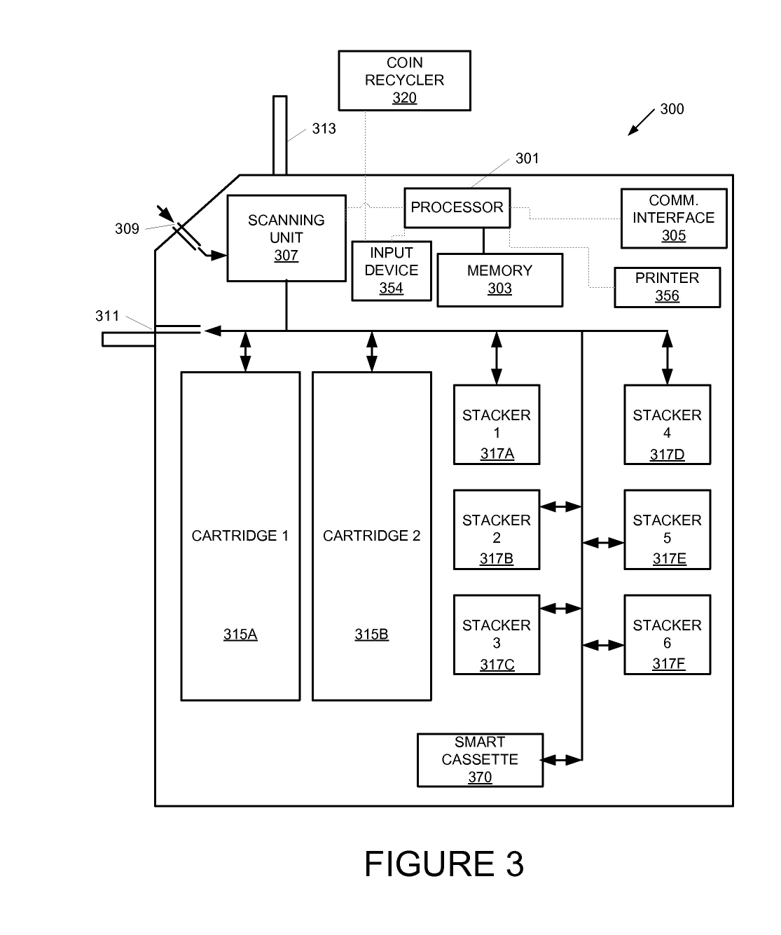

FIG. 3 illustrates an example of a money handling device 300 which may further include a display device 313 to present messages and/or other information to a user. For example, display 313 may be configured to display a recycler balance, a transaction interface, a current deposit count, security options, transportation options and the like.

Money handling device 300 may handle one or both of deposits and dispersal of money (cash and/or checks). Money deposits may be referred to as M1 deposits that includes currency (banknotes and coins) and bank money (personal checks, business checks, travelers checks, and the like). For example, a customer may deposit his/her pay check and receive some cash while depositing the remainder of the deposited funds into the customer's account.

One or more input devices 354 such as an antenna, serial port, infrared port, Bluetooth module, firewire port, keypad, keyboard, mouse, touchscreen, fingerprint scanner, retinal scanner, proximity card reader, RFID scanner and/or writer, magnetic card reader, barcode reader, and/or combinations thereof may also be included in or connected to money handling device 300.

In addition, a coin recycler 320 or other input mechanism to capture non-cash items may also be coupled to the money handling device 300. The coin recycler 320 may be a stand-alone device that is coupled to the money handling device 300 via one or more of the above-identified input devices 354. This would allow information regarding what coins were deposited into the coin recycler 320 or withdrawn from the coin recycler to be communicated to processor 301 for appropriate crediting, debiting, or other action. In an alternative embodiment, persons of skill in the art will understand that the coin recycler 320 may be integral with and integrated into the money handling device 300.

One or more printers 356 may also be included in or connected to money handling device 300 for printing receipts and notifications as well.

In money handling device 300, recycling units (also known as stackers, rolled-stored modules, or recycling modules) 317 and/or cartridges 315 may be configured to store money, including checks and cash. One or more stackers 317 and/or cartridges 315 may also provide storage for overflow money such as, for example, a larger quantity of one or more denominations that can be physically stored in stacker 317 and/or cartridge 315.

Money may be inserted through input slot 309 and withdrawn through withdrawal slot 311. Some of stackers 317 may be used to store and organize cash based on denomination while one or more of stackers 317 may be used to store deposited checks. For example, all $5 bills may be stored in stacker 1 (stacker 317A) while all $20 bills may be stored in stacker 2 (stacker 317B) and deposited checks may be stored in stacker 3 (stacker 317C). Cartridges 315A and 315B, on the other hand, may be used to store overflow currency and/or checks and/or for transport. Thus, if stackers 317 become full, additional money that is deposited into money handling device 300 may be stored in an overflow cartridge such as cartridge 315B. One of cartridges 315 may be designated as a transport cartridge that stores currency to be withdrawn from the machine and transported to the bank. Alternatively or additionally, one or more of cartridges 315 may be used as an unfit bill store for money determined to be defective to a degree that it should be taken out of circulation. Cartridges 315 and stackers 317 may further be removable for easier access or transport.

Scanning unit 307 may be configured to scan (e.g., optically and/or magnetically) money that is inserted into money handling device 300. Scanning unit 307 may be configured to detect defects, counterfeits, denomination, type of cash (for example, which country the currency originates from) and the like. Scanning unit 307 may further be configured to refuse money (either through input slot 309 or withdrawal slot 311) if it cannot be properly recognized or if the currency is deemed to be an authorized reproduction. Scanning unit 307 may send such data to processor 301 which may, in turn, save the data in memory 303.

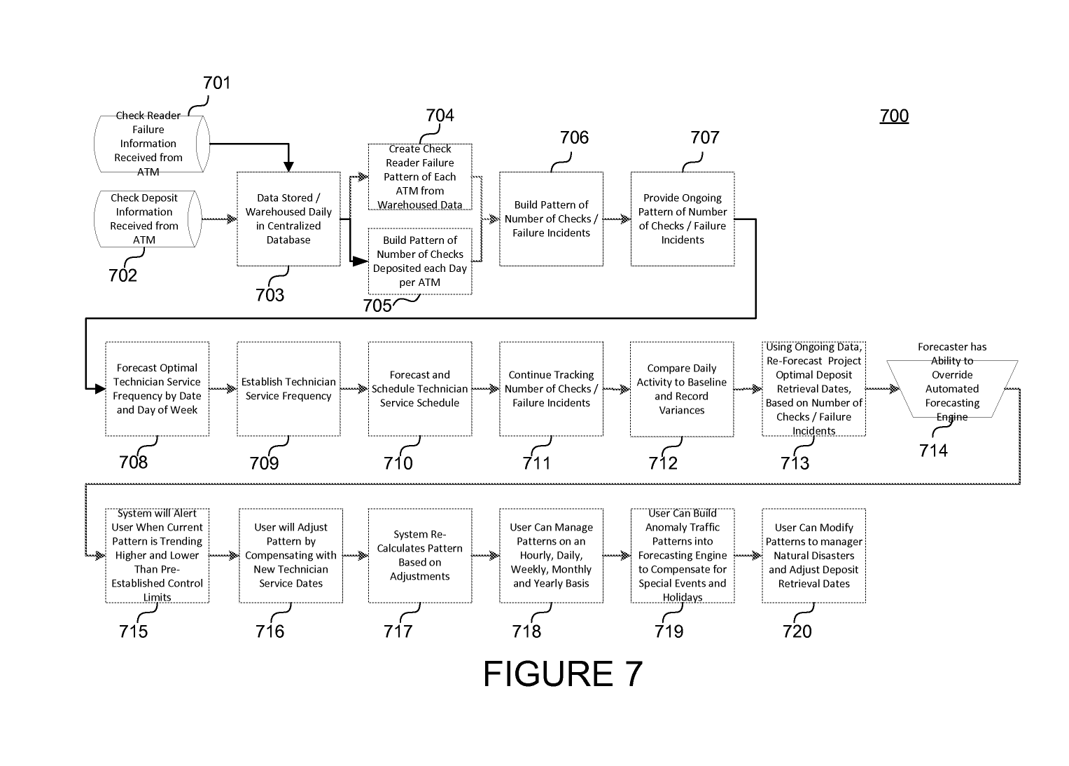

With some embodiments, money handling machine 300 includes a check reader (corresponding to block 704 as shown in FIG. 7). A poor quality check may cause a check reader jam, so a bad check may cause a failure. As a consequence, a technician may make adjustments to the check reader in order for checks to flow through money handling machine 300 correctly. If the feed path of the reader is out of alignment, it may cause a jammed check or checks. Based on the frequency of failures (multiple) on the reader device, a technician may replace that module within cash handling machine 300.

Further, money handling device 300 may include one or more mechanical or electromechanical systems (not shown) for automatically transferring currency between stackers 317, cartridges 315, input slot 309 and withdrawal slot 311 in money handling device 300. For example, currency may automatically be withdrawn from stackers 317 and directed into cartridge 315A for storage using a series of motorized rollers. In another example, currency stored in cartridge 315A may be withdrawn and organized and stored into stackers 317 according to denomination. Using such systems to facilitate the automated movement of money between storage components and other portions of money handling device 300 may provide efficiency and security by alleviating some of the need to manually handle currency stored within money handling device 300.

If desired, each stacker 317 may be capable of accepting and dispensing a single denomination of cash and accepting deposited checks. Each stacker and any overflow cassette (for example, for storing overflow quantities of one or more denominations) may be configured with one or more thresholds via a local or remote graphical user interface. Example thresholds include, but are not limited to, a minimum, a maximum, and a target. The thresholds may be assigned arbitrarily or by any desired methodology. Data representing each of the thresholds may be stored in a computer-readable medium such as memory 303.

A minimum threshold may be, for example, a lower bill quantity threshold (which may be a calculated quantity) for a given denomination of cash. Once the minimum is reached or approached, the client may be in danger of running out of a specific denomination given historical cash usage patterns.

A target threshold may be a desired bill quantity for a given denomination of cash. This may be the calculated quantity for a given denomination that may, for example, reduce or even minimize transportation runs given module capacity and historical cash usage patterns.

A maximum threshold may be the upper bill quantity threshold (which may be a calculated quantity) for a given denomination. Once the maximum threshold is reached or approached, the client may be in danger of running out of capacity for a specific denomination given module capacity and historical cash usage patterns.

Money handling device 300 may also be connected to a financial institution via network 210. This may enable the financial institution to monitor and/or control on a continuous or intermittent (e.g., periodic) basis how much cash, currency, or coins are contained in the money handling device 300.

Also, a maximum threshold may be predetermined and/or calculated for deposited checks. When the number of deposited checks reaches the maximum threshold, a transaction processing system may generate an alert that the checks at the corresponding money handling device needs to be pulled. For example, personnel may be dispatched to the identified money handling device to extract the checks in order to empty the corresponding stacker with a projected period time. For example, stacker 317C may be currently filled so that personnel should pull the deposited checks as soon as possible. Also, transaction processing system 212 (as shown in FIG. 2) may forecast that stacker 317C (used for storing checks in the above example) may become full within a projected period of time. If so, personnel should pull checks from the identified money handling device within the projected period of time.

FIG. 4 illustrates flow chart 400 of example steps that may be performed for managing deposited checks at money handling device 201-204 by transaction server 212 (as shown in FIG. 2) according to one or more aspects of the present disclosure. At block 401, transaction server 212 receives deposit information from the i^{th} money handling device (money handling device 201, 202, 203, or 204).

At block 402, transaction server 212 forecasts the number of deposited checks at the i^{th} money handling device 201-204 by projecting the number at a subsequent time. The forecasting may be determined by analyzing previous activity from storage 215 in order to obtain a pattern of deposited checks over a time period (for example, day of week, day of month, hour of the day, and the like). Transaction server 212 then compares the forecasted number to a limit (e.g., a threshold). For example, money handling device 201-204 may have one or more bins for storing deposited checks (e.g., approximately a thousand). Depending on the usage at the money handling device, the check storage capacity may be sufficient for a time period ranging from, e.g., several days to several weeks. If the forecasted number exceeds the limit, the i^{th} money handling device (201-204) is identified for pulling, where the deposited checks are removed from the i^{th} money handling device.

Transaction server 212 continues to analyze the remaining money handling devices 201-204 at blocks 403-404. If there are additional money handling devices, server 212 proceeds to block 405 and repeats blocks 401-404. At block 406, transaction server 212 generates a report identifying the money handling devices where the deposited checks need to be removed. The report may also include the location of the identified money handling device 201-204 by accessing location information from database 214. The report may contain some or all of the identified money handling devices 201-204, in which a route is generated for personnel (e.g., armored guards) to collect deposits at the identified money handling devices.

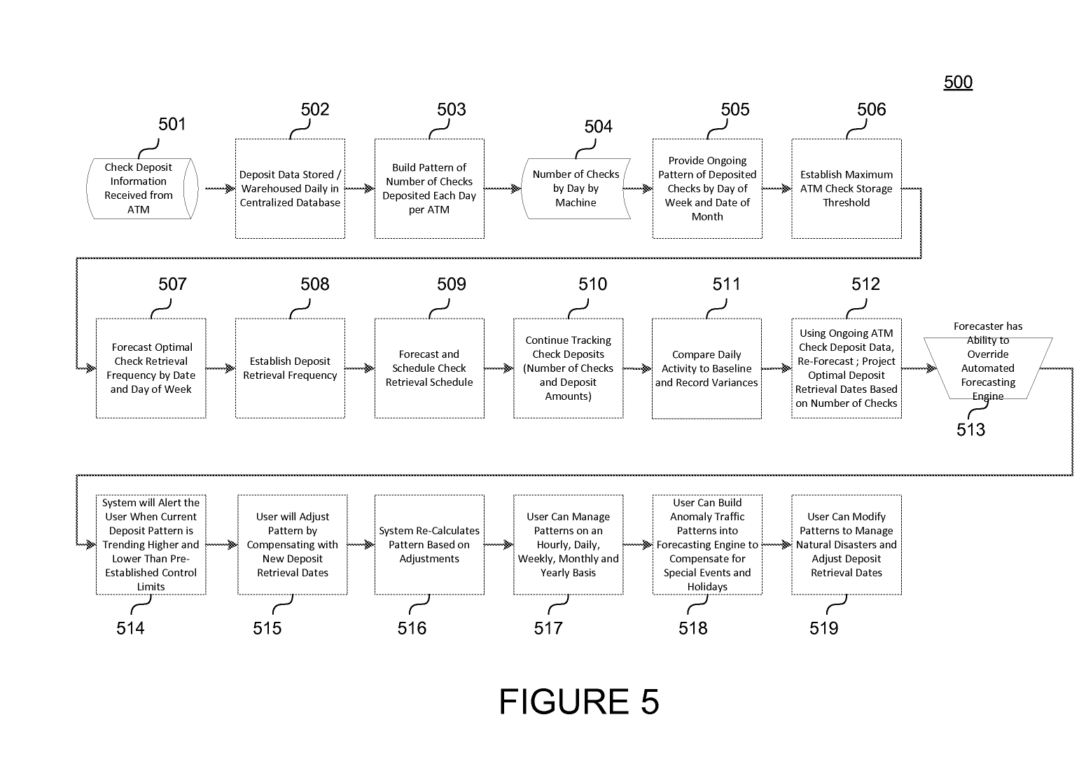

Process 400 and/or processes 500-700, as discussed with FIGS. 5-7, respectively, are example processes that may be executed on transaction server 212 and/or other computers.

FIG. 5 illustrates flow chart 500 of example steps that may be performed for check deposit forecasting at a money handling device according to one or more aspects of the present disclosure. At block 501, a computer system (e.g., transaction server 212 as shown in FIG. 2) obtains deposit information for the money handling machines, e.g., automated teller machines (ATMs). The deposited information includes the number of deposited checks on a time basis (e.g., day of week, date of month, or hour). The history of deposit activity can then be stored in a central storage facility (e.g., storage 215 as shown in FIG. 2) at block 502 so that the computer system can assess the stored deposit information and determine a pattern of deposit activity for a particular time period at block 503. For example, the computer system can predict the number of deposited checks for a Tuesday following a holiday. Consequently, the computer system can project the number of deposited checks at blocks 504-505 and obtain a threshold from the pattern at block 506. For example, the threshold may be a percentage of the predicted number of a time period. When the projected number of deposited checks exceeds the threshold, the corresponding money handling device can be scheduled for check retrieval before the check bin fills up at blocks 507-509.

While the scheduled check retrieval may be based on previous information at blocks 507-509, the current (on-going) number of deposited checks for a time period may be trended at blocks 510-512. The current number may differ from the projected number for different reasons. For example, another financial institution may have removed or added an ATM in the area, causing the deposit activity to dramatically increase or decrease, respectively. If the trended number is sufficiently different from the projected number, the number of deposited checks can be re-forecasted at block 512. The user can over-ride the forecast at block 513. If the trending is sufficiently different from the previously established pattern of deposited checks as determined at block 514, the pattern can be adjusted at blocks 515-516.

The user can also manage the deposited check patterns at blocks 517-519. For example, a pattern may be adjusted for holidays and for special events, e.g., conventions. In addition, a natural disaster may be predicted. For example, the path of a hurricane or a flooded area may be predicted, in which there are outages of money handling machines in the affected regions. Consequently, process 500 may result in an indication that deposit activity could migrate to money handling devices in a neighboring area and accordingly adjust deposit patterns.

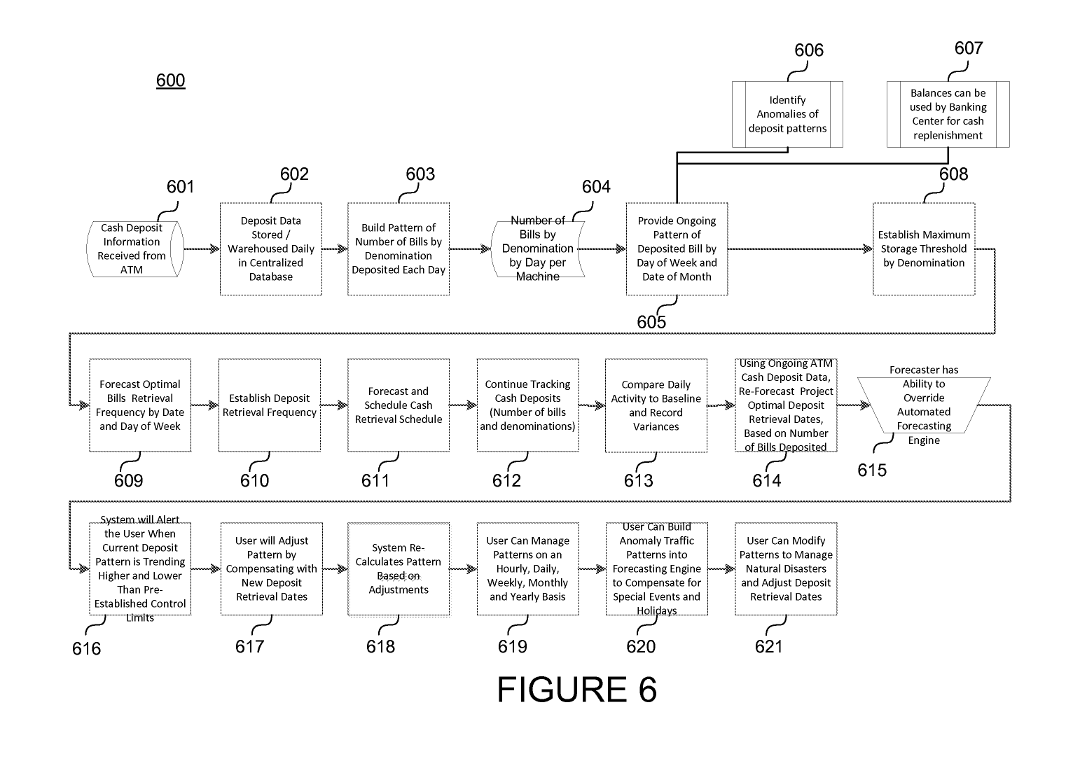

FIG. 6 illustrates flow chart 600 of example steps that may be performed for deposit forecasting for bank notes (paper currency or bills) at a money handling device according to one or more aspects of the present disclosure. The actions of process 600 parallels the actions of process 500 in which deposits of bills are considered rather than checks. With some embodiments, a computer system may separately execute processes 500 and 600. However, some embodiments may combine processes 500 and 600 to include both deposited checks and cash. For example, when the projected number of deposited checks or any bill denominations exceeds a corresponding threshold, retrieval of deposits can be scheduled.

At block 601, a computer system (e.g., transaction server 212 as shown in FIG. 2) obtains deposit information for the money handling machines. The deposited information includes the number of deposited bills based on different denominations on a time basis (e.g., day of week, date of month, or hour). The history of deposit activity can then be stored in a central storage facility (e.g., storage 215 as shown in FIG. 2) at block 602 so that the computer system can assess the stored deposit information and determine a pattern of deposit activity for a particular time period at block 603. Consequently, the computer system can project the number of deposited bills per denomination at blocks 604-605 and obtain a threshold from the pattern at blocks 608. For example, the threshold may be a percentage of the predicted number at a subsequent time. When the projected number of deposited bills exceeds the threshold, the corresponding money handling device can be scheduled for check retrieval before the check bin fills up at blocks 609-611.

Block 605 may include sub-processes at blocks 606 and 607. At block 606, the computer system may identify anomalies of deposit patterns, for example, to support criminal investigations. As an example, the number of hundred dollar bills may be excessive and may be indicative of possible illegal activities by a depositor. At block 607, the computer system may also use deposit balances for bills of different denominations to determine whether any denominations need to be replenished. A money handling device may comprise a currency recycler that is configured to dispense the same currency that was earlier deposited. Consequently, some of the deposited bills may be dispensed to other customers.

While the scheduled bill retrieval may be based on previous information at blocks 609-611, the current (on-going) number of deposited bills for a time period may be trended at blocks 612-614. The current number may differ from the projected number for different reasons. For example, another financial institution may have removed or added an ATM from the area, causing the deposit activity to dramatically increase or decrease, respectively. If the trended number is sufficiently different from the projected number, the number of deposited checks can be re-forecasted at block 614. The user can over-ride the forecast at block 615. If the trending is sufficiently different from the previously established pattern of deposited checks as determined at block 616, the pattern can be adjusted at blocks 617-618.

The user can also manage the deposited bill patterns at blocks 619-621. For example, a pattern may be adjusted for holidays and for special events, e.g., conventions. In addition, a natural disaster may be predicted. For example, the path of a hurricane or a flooded area may be predicted, in which there are outages of money handling machines in the affected regions. Consequently, process 600 may indicate that deposit activity could migrate to money handling devices in a neighboring area and accordingly adjust deposit patterns.

FIG. 7 illustrates a flow chart of example steps that may be performed for forecasting deposit faults at a money handling device according to one or more aspects of the present disclosure.

At blocks 701 and 702, a computer system (e.g., transaction server 212 as shown in FIG. 2) obtains check reader failure information and check deposit information from the money handling machines, e.g., automated teller machines. The check deposit information includes the number of deposited checks on a time basis (e.g., day of week, date of month, or hour). The history of check deposit activity and check reader failures can then be stored in a central database (e.g., database 215 as shown in FIG. 2) at block 703 so that the computer system can assess the stored check deposit information and check reader failure information and determine a pattern of check reader failures at block 704 and a pattern of the number of deposited checks per unit time at block 705.

From the patterns of check reader failures and the number of deposited checks, the pattern of the ratio (number of deposited checks/number of reader failures) per money handling device is built at block 706. The ratio pattern is updated at block 707 to obtain an on-going pattern of the ratio.

The computer system can predict the ratio for different timeframes, for example, the ratio for a Tuesday following a holiday. Consequently, the computer system can project the ratio and forecast a technician service schedule from the projection at blocks 708-710.

While scheduled technician servicing may be based on previous information at blocks 708-710, the current (on-going) ratio for a time period may be trended at blocks 711-713. The current ratio may differ from the projected number for different reasons. The ratio may vary based on a number of factors. For example, weather may influence customer behavior and how well the check reader performs. Also, the quality of check presented into cash handling machine 300 may vary based on the customer segment presenting the checks. In addition, environmental factors may influence the ratio, e.g., dust in Arizona and California and humidity in the Mississippi valley locations. If the trended number is sufficiently different from the projected number, the ratio can be re-forecasted at block 713. With some embodiments, both the ratio and the number of deposited checks are separately tracked. The user can over-ride the forecast at block 714. If the trending is sufficiently different from the previously established pattern of ratio, as determined at block 715, the pattern can be adjusted at blocks 716-717. In such a case, the technician schedule can be adjusted.

The user can also manage the ratio patterns at blocks 718-720. For example, a pattern may be adjusted for holidays and for special events, e.g., conventions. In addition, a natural disaster may be predicted. For example, the path of a hurricane or a flooded area may be predicted, in which there are outages of money handling machines in the affected regions. For example, a natural disaster may shift the customer demographic and transaction traffic and may alter how cash handling machine 300 is being used, thus causing the ratio value to change.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed:

1. A method for assessing a status of a transaction system, the transaction system including a first money handling device, the method comprising:
obtaining, by at least one computing device, deposit information from the first money handling device;
determining, based on the deposit information by the at least one computing device, a number of deposited monetary items at the first money handling device to obtain a projected number of deposited monetary items at a subsequent time;
determining whether the projected number of deposited monetary items exceeds a threshold;
tracking the number of deposited monetary items at the first money handling device;
determining whether the tracked number of deposited monetary items is trending differently from the projected number of deposited monetary items;
when the tracked number of deposited monetary items currently deposited at the first money handling device is trending differently from the projected number, reforecasting the number of deposited monetary items to obtain a modified projected number of deposited monetary items; and
based on the reforecasting, generating, by the at least one computing device, data indicative of whether deposits should be removed from the first money handling device, the deposits including the deposited monetary items.

2. The method of claim 1, further comprising:
building a pattern of the number of deposited monetary items for the first money handling device; and
wherein the projecting is based on the pattern.

3. The method of claim 1, further comprising:
in response to the reforecasting, adjusting an indicator that is indicative whether the deposited monetary items should be removed from the first money handling device.

4. The method of claim 1, further comprising:
compensating the projected number of deposited monetary items based on an event, the event occurring externally to the first money handling device.

5. The method of claim 1, further comprising:
determining the threshold based on the deposit information.

6. The method of claim 5, further comprising:
modifying the projected number of deposited monetary items from time-dependent characteristics of a check pattern.

7. The method of claim 1, wherein the projecting comprises:
modifying the projected number of monetary items at the first money handling device when a natural disaster occurs.

8. The method of claim 7, wherein the modifying comprises:
determining whether a second money handling device is adversely affected by the natural disaster, the transaction system comprising the second money handling device; and
altering the projected number of monetary items at the first money handling device based on forecasted deposits at the second money handling device.

9. The method of claim 1, wherein the deposit information includes check information about deposited checks at the first money handling device, the method further comprising:
projecting a number of deposited checks at the first money handling device to obtain a projected number of deposited checks;
determining whether the projected number of deposited checks exceeds a check threshold; and
based on the determining, generating the indicator so that the indicator is indicative of whether the deposited checks should be removed from the first money handling device.

10. The method of claim 9, further comprising:
building a check pattern of the number of deposited checks at the first money handling device; and
wherein the projecting is based on the check pattern.

11. The method of claim 10, further comprising:
tracking the number of deposited checks at the first money handling device; and
determining whether the tracked number of deposited checks is trending differently from the projected number of deposited checks.

12. The method of claim 1, wherein the deposit information includes cash information about deposited cash at the first money handling device, the method further comprising:
projecting an amount of deposited cash at the first money handling device to obtain a projected amount of deposited cash;
determining whether the projected amount of cash exceeds a cash threshold; and
based on the determining, generating the indicator so that the indicator is indicative whether the deposited cash should be removed from the first money handling device.

13. The method of claim 12, further comprising:
building a cash pattern of the number of deposited cash at the first money handling device, the cash including at least one denomination of bank notes; and
wherein the projecting is based on the cash pattern.

14. The method of claim 1, further comprising:
tracking the amount of deposited cash at the first money handling device; and
determining whether the tracked amount of deposited cash is trending differently from the projected amount of deposited cash.

15. An apparatus comprising:
at least one memory; and
at least one processor coupled to the at least one memory and configured to perform, based on instructions stored in the at least one memory:
obtaining deposit information from a money handling device;
determining a threshold based on the deposit information;
projecting a number of deposited monetary items at the money handling device to obtain a projected number of deposited monetary items at a subsequent time;
determining whether the projected number of deposited monetary items exceeds the threshold;
tracking the number of deposited monetary items at the first money handling device;
determining whether the tracked number of deposited monetary items is trending differently from the projected number of deposited monetary items;
when the tracked number of deposited monetary items currently deposited at the money handling device is trending differently from the projected number, reforecasting the number of deposited monetary items to obtain a modified projected number of deposited monetary items; and
in response to the reforecasting, generating an indicator that is indicative whether deposits should be removed from the money handling device, the deposits including the deposited monetary items.

16. The apparatus of claim 15, wherein the at least one processor is further configured to perform:
altering the indicator based on the trending.

17. The apparatus of claim 15, wherein the at least one processor is further configured to perform:
compensating the projected number of deposited monetary items based on an event, the event occurring externally to the money handling device.

18. The apparatus of claim 15, wherein the deposited monetary items include deposited checks.

19. A non-transitory computer-readable storage medium storing computer-executable instructions that, when executed, cause a processor at least to perform operations comprising:
obtaining deposit information from a money handling device;
projecting, from the deposit information, a number of deposited monetary items at the money handling device to obtain a projected number of deposited monetary items at a subsequent time;
tracking the number of deposited monetary items at the money handling device;
determining whether the tracked number of deposited monetary items is trending differently from the projected number of deposited monetary items;
when the tracked number of deposited monetary items currently deposited at the money handling device is trending differently from the projected number, reforecasting the number of deposited monetary items to obtain a modified projected number of deposited monetary items; and
based on the reforecasting, generating an indicator whether deposits should be removed from the money handling device, the deposits including the deposited monetary items.

20. The non-transitory computer-readable storage medium of claim 19, wherein the deposited monetary items include deposited checks.
